(19) United States
(12) Patent Application Publication
(10) Pub. No.: US 2025/0130830 A1
(43) Pub. Date: Apr. 24, 2025

(54) MANAGING CLOUD SNAPSHOTS IN A DEVELOPMENT PLATFORM

(71) Applicant: VMware, Inc., Palo Alto, CA (US)

(72) Inventors: Nikola Bratanov, Sofia (BG); Ventsyslav Raikov, Sofia (BG); Plamen Veselinov Peev, Sofia (BG); Kristina Zhelyazkova, Sofia (BG); Ina Uzunova, Sofia (BG)

(73) Assignee: VMware, Inc., Palo Alto, CA (US)

(21) Appl. No.: 18/382,231

(22) Filed: Oct. 20, 2023

(51) Int. Cl. G06F 9/455

(52) U.S. Cl. CPC G06F 9/45558; G06F 2009/45562

(57) ABSTRACT

Managing cloud snapshots in a development platform is described herein. One example method includes creating a snapshot of a virtual computing instance (VCI), provided by a cloud provider, using a development platform, receiving a request to revert to the snapshot, and performing a revert operation responsive to receiving the request. The revert operation can include creating a new boot disk on the cloud provider to replace a current boot disk in the development platform, creating a new data disk to replace a current data disk associated with the VCI, powering off the VCI and detaching the boot disk and the data disk, attaching the new boot disk and the new data disk to the VCI, powering on the VCI, and deleting the detached boot disk and the detached data disk.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for managing cloud snapshots in a development platform according to one or more embodiments of the present disclosure.

FIG. 2 is a flow chart associated with managing cloud snapshots in a development platform according to one or more embodiments of the present disclosure.

FIG. 3 illustrates a system for managing cloud snapshots in a development platform according to one or more embodiments of the present disclosure.

FIG. 4 is a diagram of a machine for managing cloud snapshots in a development platform according to one or more embodiments of the present disclosure.

### DETAILED DESCRIPTION

As referred to herein, a virtual computing instance (VCI) covers a range of computing functionality. VCIs may include non-virtualized physical hosts, virtual machines (VMs), and/or containers. A VM refers generally to an isolated end user space instance, which can be executed within a virtualized environment. Other technologies aside from hardware virtualization that can provide isolated end user space instances may also be referred to as VCIs. The term “VCI” covers these examples and combinations of different types of VCIs, among others. VMs, in some embodiments, operate with their own guest operating systems on a host using resources of the host virtualized by virtualization software (e.g., a hypervisor, virtual machine monitor, etc.).

Multiple VCIs can be configured to be in communication with each other in an SDDC. In such a system, information can be propagated from a client (e.g., an end user) to at least one of the VCIs in the system, between VCIs in the system, and/or between at least one of the VCIs in the system and a server. SDDCs are dynamic in nature. For example, VCIs and/or various application services, may be created, used, moved, or destroyed within the SDDC. When VCIs are created, various processes and/or services start running and consuming resources. As used herein, “resources” are physical or virtual components that have a finite availability within a computer or SDDC. For example, resources include processing resources, memory resources, electrical power, and/or input/output resources.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

A development platform can be used to configure and/or provision resources in a virtualized environment. One example of such a development platform is VMware's vRealize Automation (sometimes referred to herein as “vRA”). vRA is a cloud management layer that sits on top of one or more clouds (e.g., different clouds). It can provision complex deployments and offer governance and management of these workloads and the resources in the cloud. A development platform in accordance with the present disclosure can be designed to automate multiple clouds with secure, self-service provisioning.

In vRA, customers can create and use a cloud provider (e.g., Google Cloud Platform (GCP)) endpoint to deploy and manage resources on GCP. When a GCP VCI is provisioned in vRA Day-2 operations, like ‘Power On’, ‘Power Off’, ‘Add Disk’ or other can be performed. During the operation of the VCI, the state of its boot disk and the states of its attached disks could change multiple times. To track the machine states, vRA provides a functionality to create and delete snapshots for a machine. Previously, those snapshots were managing only the boot disk of the machine.

It would be desirable to have functionality allowing management of GCP snapshots for a VCI and its boot and data disks as a single operation. This management can include create, delete and revert to those snapshots using Day-2 operations. However, GCP only supports creation of snapshot per disks and does not offer a way to create a unified snapshot that contains the state of the VCI's disks and use it for a revert operation. The revert has similar limitations; a user can only create a new disk from existing snapshot in GCP. It is not possible under previous approaches to revert an existing disk to its previous state.

Embodiments of the present disclosure provide a way to create a single snapshot in vRA that holds the necessary data needed to revert a machine to a snapshot and delete its snapshots on GCP. The revert is done by executing a series of GCP operations that are already supported in vRA. It performs revert of every disk of the machine that existed at the time of snapshot creation. Embodiments herein modify the way a snapshot is created and add a new Day2 operation referred to as “Revert To Snapshot.” For revert and delete operations to function, the ‘Create Snapshot’ operation makes snapshots of the machine's boot and attached disks on GCP and provides a way to link the disks with their snapshots in vRA. Snapshot creation can make one or more new snapshot objects on GCP of the boot and all data disks of the machine. Snapshot creation can make one snapshot state object that is saved locally in vRA database. This state contains the necessary information for executing the other snapshot operations (e.g., delete and revert). Further, this object holds the ID of every snapshot created on GCP. Those IDsd lead to the snapshots for each disk on GCP, including the boot disk. Snapshot IDs in the snapshot state object can be stored in a composite object. The composite object contains both the disk name and the GCP snapshot ID. This is useful for revert and delete operations, because embodiments herein can differentiate for which of the VCI's existing disks there is a snapshot. Then, we can execute them only on the disks with snapshots using their IDs.

An example local snapshot state of a VCI with a boot and additional disk illustrates how disks can be saved and references to their snapshots in GCP:

```
{
  “snapshotName”: “vra-snapshot-1”,
  [
    {
      “diskName”: “disk-1”,
      “gcpId”: “google-api/projects/global/disk-snapshot-1”,
      “isBoot”: true
    },
    {
      “diskName”: “disk-2”,
      “gcpId”: “google-api/projects/global/disk-snapshot-2”,
      “isBoot”: false
    }
  ]
}
```

This state allows the performance of revert and delete operation on all a VCI's disks that have a snapshot created in GCP.

The Day2 revert operation can be constructed using a flow from GCP operations, supported by their API, which results in reverting a machine to a selected snapshot. Accordingly, a GCP VCI's boot and each of its attached disks are recreated from a source snapshot as GCP does not allow reversion to the existing disks. Additionally, the action is designed that in case of failure the VCI is reverted to its previous state. For example, for each successful operation, its opposite operation can be saved as a Callable function in stack object. When an operation completes without failures, its reverse operation is saved on top of the stack. That way, the order in which the opposite actions are to be performed is kept. In case of failure, each operation in the stack can be started from top to bottom and executed synchronously.

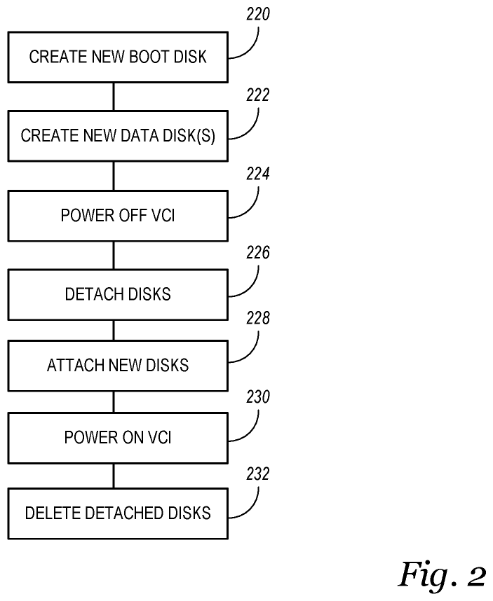

The flow of the revert operation includes different actions related to GCP VCIs and disks. The flow can be executed in a sequence of steps described in more detail below in connection with FIG. 2.

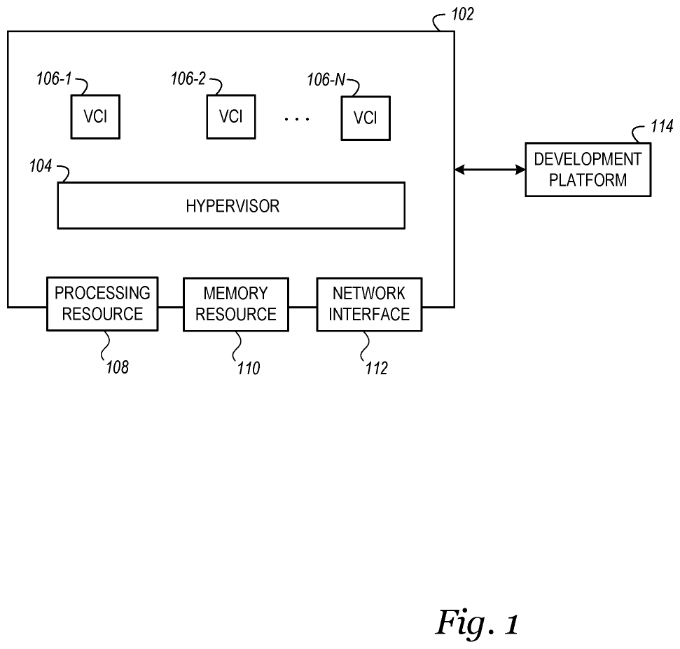

FIG. 1 is a diagram of a host and a system for managing cloud snapshots in a development platform according to one or more embodiments of the present disclosure. The host 102 can be provisioned with processing resource(s) 108 (e.g., one or more processors), memory resource(s) 110 (e.g., one or more main memory devices and/or storage memory devices), and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of VCIs 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs 106 can be local and/or remote to the host 102 (e.g., the VCIs 106 can be ultimately executed by hardware that may not be physically tied to the VCIs 106). For example, in a software defined data center, the VCIs 106 can be provisioned with resources that are generally available to the software defined data center and are not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. In some embodiments, the host 102 can be connected to (e.g., in communication with) a development platform 114. Though not shown in FIG. 1, The development platform can be connected to one or more clouds via one or more cloud providers (e.g., AWS, etc.).

FIG. 2 is a flow chart associated with managing cloud snapshots in a development platform according to one or more embodiments of the present disclosure. The flow of the revert operation illustrated in FIG. 2 includes different actions related to GCP VCIs and disks. The flow of the revert operation in accordance with embodiments herein can be executed in a sequence of steps. From the local snapshot state, it can be determined which VCI's disk from the deployment has a snapshot. Such determination can be made by using the composite object that was saved in the snapshot state. From the composite object, there are pairs of disk names and snapshot IDs from the cloud provider (GCP in this example) that can be used when recreating the disks.

At 220, a new boot disk is created on GCP from a GCP snapshot that will be used to replace the current machine boot disk in the development platform. A machine has only one boot disk. Responsive to this operation, a delete boot disk operation can be added to the stack of rollback operations.

At 222, a new data disk is created from a GCP snapshot for each attached disk that the machine has in the development platform. A delete data disk operation can be added for every successfully created disk to the stack of rollback operations responsive to this operation.

At 224, the machine instance is powered off on GCP. This is a necessary step, because disks cannot be attached or detached from the instance if the VCI is powered on. A power on operation can be added to the stack of rollback operations responsive to this operation.

At 226, all boot and additional disks that the machine has are detached. An attach disk operation for every detached disk can be added to the stack of rollback operations responsive to this operation.

At 228, all disks that were created in steps 220 and 222 added to the VCI. A detach disk operation is added for every attached disk to the stack of rollback operations responsive to this operation.

At 230, the VCI is powered on. By doing so, the VCI is back to a state where it can be used. A power off operation can be added to the stack of rollback operations responsive to this operation.

At 232, each of the disks that were detached from the machine from GCP are deleted to avoid leaking old resources on GCP. If failure is detected at this step, the old disks are not deleted.

After the steps illustrated in FIG. 2 are completed, what remains is a VCI with a new boot disk and data disks that are constructed from captured snapshots of those disks. Every detached resource is deleted, and no additional resources are left on the customer's vRA environment and on the GCP cloud. In response to a ‘Delete Snapshot’ request, then like the revert, the composite snapshot state object can be used to delete the GCP snapshot of every disk of the machine that has a snapshot.

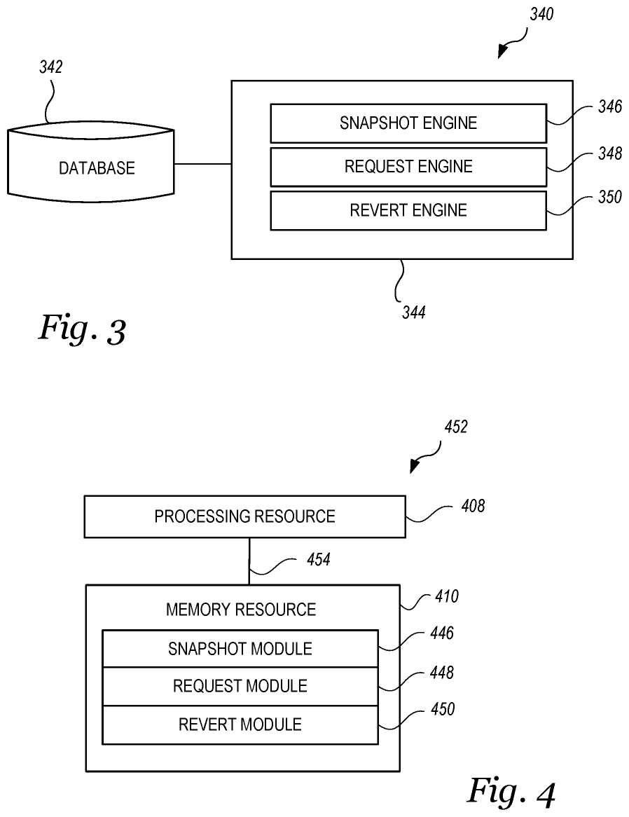

FIG. 3 illustrates a system 340 for managing cloud snapshots in a development platform according to one or more embodiments of the present disclosure. The system 340 can include a database 342, a subsystem 344, and/or a number of engines, for example a snapshot engine 346, a request engine 348, and/or a revert engine 350, and can be in communication with the database 342 via a communication link. The system 340 can include additional or fewer engines than illustrated to perform the various functions described herein. The system 340 can represent program instructions and/or hardware of a machine (e.g., machine 452 as referenced in FIG. 4, etc.). As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the snapshot engine 346 can include a combination of hardware and program instructions that is configured to XXXXXXXXXXX. In some embodiments, the request engine 348 can include a combination of hardware and program instructions that is configured to XXXXXXXXXX. In some embodiments, the revert engine 350 can include a combination of hardware and program instructions that is configured to perform a revert operation responsive to receiving the request. The revert operation can include creating a new boot disk on the cloud provider to replace a current boot disk in the development platform, creating a new data disk to replace a current data disk associated with the VCI, powering off the VCI and detaching the boot disk and the data disk, attaching the new boot disk and the new data disk to the VCI, powering on the VCI, and deleting the detached boot disk and the detached data disk.

FIG. 4 is a diagram of a machine 452 for managing cloud snapshots in a development platform according to one or more embodiments of the present disclosure. The machine 452 can utilize software, hardware, firmware, and/or logic to perform a number of functions. The machine 452 can be a combination of hardware and program instructions configured to perform a number of functions (e.g., actions). The hardware, for example, can include a number of processing resources 408 and a number of memory resources 410, such as a machine-readable medium (MRM) or other memory resources 410. The memory resources 410 can be internal and/or external to the machine 452 (e.g., the machine 452 can include internal memory resources and have access to external memory resources). In some embodiments, the machine 452 can be a virtual computing instance (VCI) or other computing device. The term “VCI” covers a range of computing functionality. The term “virtual machine” (VM) refers generally to an isolated user space instance, which can be executed within a virtualized environment. Other technologies aside from hardware virtualization can provide isolated user space instances, also referred to as data compute nodes. Data compute nodes may include non-virtualized physical hosts, VMs, containers that run on top of a host operating system without a hypervisor or separate operating system, and/or hypervisor kernel network interface modules, among others. Hypervisor kernel network interface modules are non-VM data compute nodes that include a network stack with a hypervisor kernel network interface and receive/transmit threads. The term “VCI” covers these examples and combinations of different types of data compute nodes, among others.

The program instructions (e.g., machine-readable instructions (MRI)) can include instructions stored on the MRM to implement a particular function (e.g., an action such as provisioning). The set of MRI can be executable by one or more of the processing resources 408. The memory resources 410 can be coupled to the machine 452 in a wired and/or wireless manner. For example, the memory resources 410 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 410 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, optical memory, and/or a solid state drive (SSD), etc., as well as other types of machine-readable media.

The processing resources 408 can be coupled to the memory resources 410 via a communication path 454. The communication path 454 can be local or remote to the machine 452. Examples of a local communication path 454 can include an electronic bus internal to a machine, where the memory resources 410 are in communication with the processing resources 480 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 454 can be such that the memory resources 410 are remote from the processing resources 408, such as in a network connection between the memory resources 410 and the processing resources 408. That is, the communication path 454 can be a network connection. Examples of such a network connection can include a local area network (LAN), wide area network (WAN), personal area network (PAN), and the Internet, among others.

As shown in FIG. 4, the MRI stored in the memory resources 410 can be segmented into a number of modules 446, 448, 450 that when executed by the processing resources 408 can perform a number of functions. As used herein a module includes a set of instructions included to perform a particular task or action. The number of modules 446, 448, 450 can be sub-modules of other modules. For example, the revert module 450 can be a sub-module of the request module 448 and/or can be contained within a single module. Furthermore, the number of modules 446, 448, 450 can comprise individual modules separate and distinct from one another. Examples are not limited to the specific modules 446, 448, 450 illustrated in FIG. 4.

One or more of the number of modules 446, 448, 450 can include program instructions and/or a combination of hardware and program instructions that, when executed by a processing resource 408, can function as a corresponding engine as described with respect to FIG. 3. For example, the snapshot module 446 can include program instructions and/or a combination of hardware and program instructions that, when executed by a processing resource 408, can function as the snapshot engine 346.

For example, the machine 452 can include a snapshot module 446, which can include instructions to create a snapshot of a virtual computing instance (VCI), provided by a cloud provider, using a development platform. For example, the machine 452 can include a request module 448, which can include instructions to receive a request to revert to the snapshot. For example, the machine 452 can include a revert module 450, which can include instructions to perform a revert operation responsive to receiving the request. In some embodiments, the revert operation includes creating a new boot disk on the cloud provider to replace a current boot disk in the development platform. In some embodiments, the revert operation includes creating a new data disk to replace a current data disk associated with the VCI. In some embodiments, the revert operation includes powering off the VCI and detaching the boot disk and the data disk. In some embodiments, the revert operation includes attaching the new boot disk and the new data disk to the VCI. In some embodiments, the revert operation includes powering on the VCI. In some embodiments, the revert operation includes deleting the detached boot disk and the detached data disk.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 408 in FIG. 4. A group or plurality of similar elements or components may generally be referred to herein with a single element number. For example, a plurality of reference elements 104-1, 104-2, . . . , 104-N may be referred to generally as 104. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
creating a snapshot of a virtual computing instance (VCI), provided by a cloud provider, using a development platform;
receiving a request to revert to the snapshot; and
performing a revert operation responsive to receiving the request, the revert operation including:
creating a new boot disk on the cloud provider to replace a current boot disk in the development platform;
creating a new data disk to replace a current data disk associated with the VCI;
powering off the VCI and detaching the boot disk and the data disk;
attaching the new boot disk and the new data disk to the VCI;
powering on the VCI; and
deleting the detached boot disk and the detached data disk.

2. The method of claim 1, wherein the method includes storing operations as callable functions in a stack object.

3. The method of claim 2, wherein the method includes:
adding a delete boot disk operation to the stack object responsive to creating the new boot disk;
adding a delete data disk operation to the stack object responsive to creating the new data disk;
adding a power on operation to the stack object responsive to powering off the VCI;
adding an attach disk operation to the stack object responsive to detaching the boot disk and the data disk;
adding a detach disk operation to the stack object responsive to attaching the new boot disk and the new data disk; and
adding a power off operation to the stack object responsive to powering on the VCI.

4. The method of claim 3, wherein the method includes, responsive to determining that the revert operation was a failure:
performing the delete boot disk operation in the stack object;
performing the delete data disk operation in the stack object;
performing the power on operation in the stack object;
performing the attach disk operation in the stack object;
performing the detach disk operation in the stack object; and
performing the power off operation in the stack object.

5. The method of claim 2, wherein the method includes storing a name of the data disk and an identifier of the snapshot in a snapshot state object.

6. The method of claim 5, wherein the method includes deleting a snapshot of any disk associated with the VCI responsive to receiving a request to delete the snapshot.

7. The method of claim 1, wherein performing the revert operation performs a revert of every disk of the VCI that existed when the snapshot was created.

8. A non-transitory machine-readable medium having instructions stored thereon which, when executed by a processor, cause the processor to:
create a snapshot of a virtual computing instance (VCI), provided by a cloud provider, using a development platform;
receive a request to revert to the snapshot; and
perform a revert operation responsive to receiving the request, the revert operation including:
creating a new boot disk on the cloud provider to replace a current boot disk in the development platform;
creating a new data disk to replace a current data disk associated with the VCI;
powering off the VCI and detaching the boot disk and the data disk;
attaching the new boot disk and the new data disk to the VCI;
powering on the VCI; and
deleting the detached boot disk and the detached data disk.

9. The medium of claim 8, including instructions to store operations as callable functions in a stack object.

10. The medium of claim 9, including instructions to:
add a delete boot disk operation to the stack object responsive to creating the new boot disk;
add a delete data disk operation to the stack object responsive to creating the new data disk;
add a power on operation to the stack object responsive to powering off the VCI;
add an attach disk operation to the stack object responsive to detaching the boot disk and the data disk;
add a detach disk operation to the stack object responsive to attaching the new boot disk and the new data disk; and
add a power off operation to the stack object responsive to powering on the VCI.

11. The medium of claim 10, including instructions to, responsive to determining that the revert operation was a failure:
perform the delete boot disk operation in the stack object;
perform the delete data disk operation in the stack object;
perform the power on operation in the stack object;
perform the attach disk operation in the stack object;
perform the detach disk operation in the stack object; and
perform the power off operation in the stack object.

12. The medium of claim 9, including instructions to store a name of the data disk and an identifier of the snapshot in a snapshot state object.

13. The medium of claim 12, including instructions to delete a snapshot of any disk associated with the VCI responsive to receiving a request to delete the snapshot.

14. The medium of claim 8, wherein the instructions to perform the revert operation include instructions to perform a revert of every disk of the VCI that existed when the snapshot was created.

15. A system, comprising:
a snapshot engine configured to create a snapshot of a virtual computing instance (VCI), provided by a cloud provider, using a development platform;
a request engine configured to receive a request to revert to the snapshot; and
a revert engine configured to perform a revert operation responsive to receiving the request, the revert operation including:
creating a new boot disk on the cloud provider to replace a current boot disk in the development platform;
creating a new data disk to replace a current data disk associated with the VCI;
powering off the VCI and detaching the boot disk and the data disk;
attaching the new boot disk and the new data disk to the VCI;
powering on the VCI; and
deleting the detached boot disk and the detached data disk.

16. The system of claim 15, wherein the revert engine is configured to store operations as callable functions in a stack object.

17. The system of claim 16, wherein the revert engine is configured to:
add a delete boot disk operation to the stack object responsive to creating the new boot disk;
add a delete data disk operation to the stack object responsive to creating the new data disk;
add a power on operation to the stack object responsive to powering off the VCI;
add an attach disk operation to the stack object responsive to detaching the boot disk and the data disk;
add a detach disk operation to the stack object responsive to attaching the new boot disk and the new data disk; and
add a power off operation to the stack object responsive to powering on the VCI.

18. The system of claim 17, wherein the revert engine is configured to, responsive to determining that the revert operation was a failure:
perform the delete boot disk operation in the stack object;
perform the delete data disk operation in the stack object;
perform the power on operation in the stack object;
perform the attach disk operation in the stack object;
perform the detach disk operation in the stack object; and
perform the power off operation in the stack object.

19. The system of claim 16, wherein the revert engine is configured to store a name of the data disk and an identifier of the snapshot in a snapshot state object.

20. The system of claim 19, wherein the revert engine is configured to delete a snapshot of any disk associated with the VCI responsive to receiving a request to delete the snapshot.
